(19) United States
(12) Patent Application Publication
(10) Pub. No.: US 2016/0105697 A1
(43) Pub. Date: Apr. 14, 2016

(54) SYSTEM AND METHOD FOR BEFOREHAND DOWNLOADING VIDEO

(71) Applicants: HONG FU JIN PRECISION INDUSTRY (ShenZhen) CO., LTD, Shenzhen (CN); HON HAI PRECISION INDUSTRY CO., LTD, New Taipei (TW)

(72) Inventors: CHI-FENG LEE, New Taipei (TW); CHIH-YUAN HUANG, New Taipei (TW)

(21) Appl. No.: 14/862,680

(22) Filed: Sep. 23, 2015

(30) Foreign Application Priority Data
Oct. 14, 2014 (TW) 103135449

(51) Int. Cl. H04N 21/234; H04N 21/238; H04N 21/258

(52) U.S. Cl. CPC H04N 21/23406; H04N 21/23418; H04N 21/25866; H04N 21/238

(57) ABSTRACT

In a system and method for beforehand downloading video, executed in a video server connected to multiple client devices and accessed though the multiple client devices by different users, a switching action of the users of each client device is detected to add up the information of each switching action as subsection statistic information. A piecewise spot of the selected video is calculated according to the subsection statistics information of the selected video after receiving a request of a specified user for playing a selected video. The video database is controlled to transmit a video streaming behind the beginning of the selected video and the video streaming behind each subsection statistic of the selected video to the client device of the specified user at the same time.

### CROSS-REFERENCE TO RELATED APPLICATIONS

This application claims priority to Taiwan Patent Application No. 103135449 filed on Oct. 14, 2014, the contents of which are incorporated by reference herein.

### FIELD

The subject matter herein generally relates to video online streaming technology.

### BACKGROUND

Viewing videos is done using electronic systems. The systems can receive a CD-ROM or obtain the electronic files directly from either a remote or local electronic file. The electronic device can be configured to allow for the user to select a point of the video that is desired. In one example, a scroll bar can be provided to select a point during the video playing.

### BRIEF DESCRIPTION OF THE DRAWINGS

Implementations of the present technology will now be described, by way of example only, with reference to the attached figures.

FIG. 1 is a block diagram of an embodiment of a video server.

FIG. 2 is a block diagram of an embodiment of beforehand downloading video system.

FIG. 3 illustrates a presentation in accordance with an embodiment of a process of calculating a piecewise spot of the selected video according to the subsection statistics information of a selected video.

FIG. 4 illustrates a presentation in accordance with an embodiment of an effect contrast between the method for beforehand downloading video in at least one embodiment of the present application and the traditional method for downloading video.

FIG. 5 is a flowchart of an embodiment of a method for classifying the user into an appropriate user group.

FIG. 6 is a flowchart of an embodiment of a method for beforehand downloading video.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

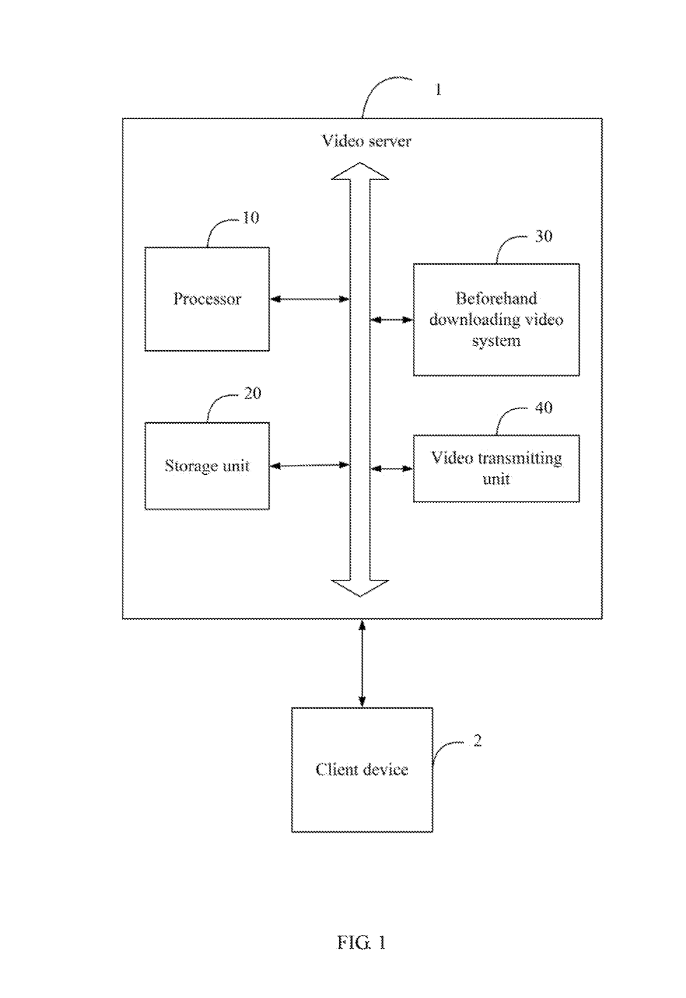

FIG. 1 illustrates a block diagram of an embodiment of a video server. In at least one embodiment, the video server 1 includes a processor 10, a storage unit 20, a beforehand downloading video system 30, and a video transmitting unit 40. The video server 1 is electrically communicating with at least one client device 2 via the Internet, in at least one embodiment, the video server 1 supplies video online playing service to multiple client devices 2. Different users access video server 1 via multiple client devices 2 and receive video online playing service supplied by the video server 1. The video server 1 transmits the video requested by users to multiple client devices 2 via the video transmitting unit 40.

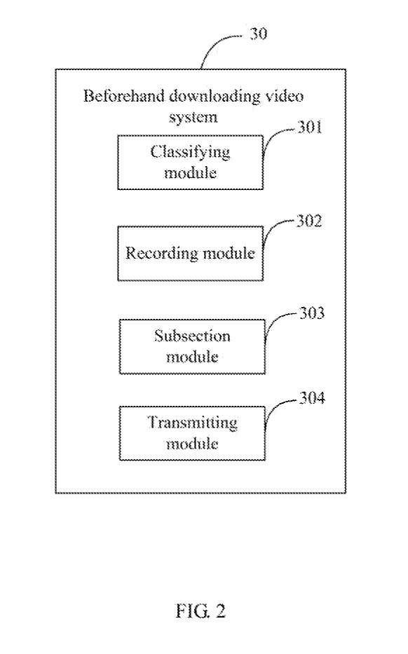

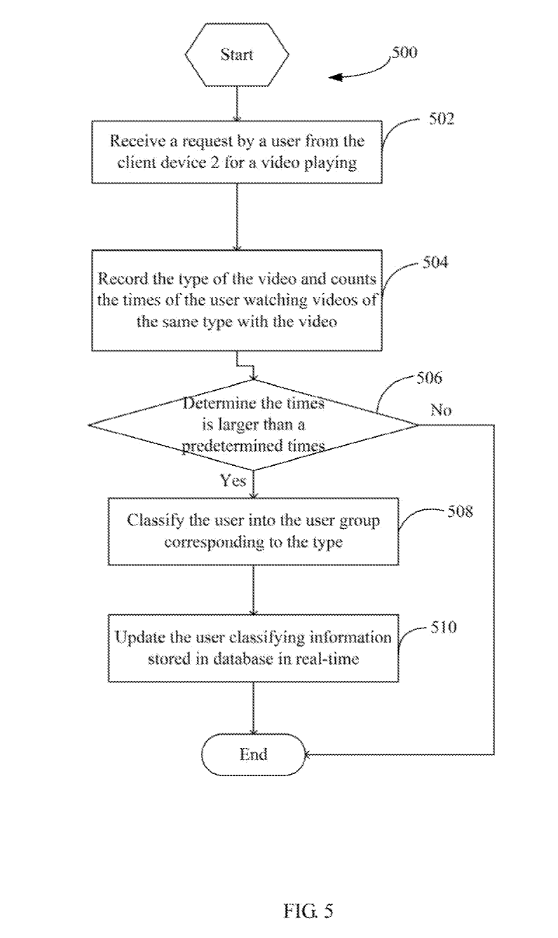

FIG. 2 illustrates the beforehand downloading video system 30 according to an embodiment of the disclosure, the beforehand downloading video system 30 includes a classifying module 301, a recording module 302, a subsection module 303, and a transmitting module 304. The one or more function modules can include computerized code in the form of one or more programs that are stored in the storage unit 20, and executed by the processor 10 to provide functions of the beforehand downloading video system 30. Descriptions of the functions of the modules 301-304 are given with reference to FIG. 5.

The classifying module 301 classifies the user into an appropriate user group according to request information of a user. In at least one embodiment, user information corresponding to each user is stored in the video server 1, the user information includes a user identification (ID) registered in the video server 1, a viewing history record of the user and so on. Wherein the user ID records and distinguishes different users, hereafter, records related to different users information are recorded and distinguished via the user ID. The classifying module 301 records the type of the video and counts the times that the user views videos of the same type while the video server 1 receives the request by a user from the client device 2 to play a video. The user is regarded as a high frequency user if the times of the user viewing videos exceeds a predetermined times (such as 10 times). The classifying module 301 classifies the user into the user group corresponding to the type of video viewed. For example, the times that the user views movies exceeds the predetermined times (such as 15 times), the user will be classified into a movie group.

In other embodiments, a record time limit or a valid time limit can be set, for example, only viewing history records generated within half year are recorded, but the previous viewing history records are cleared and are not regarded as basis for classifying the user into groups.

The recording module 302 detects a switching action of the users of each client device 2 to compile the information of each switching action as subsection statistic information, wherein the information of the switching action includes a switching point and the user corresponding to the switching action. In at least one embodiment, the recording module 302 continuously detects an operation of the users of each client device 2 while the video server 1 supplies video online playing service to multiple client devices 2. The recording module 302 also determines if the current user belongs to the user group corresponding to the type of video currently playing or not while the switching action of the user appears. The recording module 302 classifies the current user into statistic samples of the user group corresponding to the type of the currently playing video and stores the information corresponding to the switching action of the current user while the current user belongs to the user group corresponding to the type of the currently playing video.

For example, the current user named A who is playing a movie named B drags progress bar directly to a point of the movie, while the current user named A belongs to the movie group, the switching action information of the current A user will be recorded into the subsection statistic information belonging to B movie. The switching action information includes at which switching point the A user does a switching action and adds up the switching times of each switching point, wherein the switching point can be a time of the video. Oppositely, the switching action information of the current user A will be ignored and not recorded while the current user A belongs to the advertisement group. Wherein the switching action information recorded by the recording module 302 includes the switching point the user performs the switching action and ID corresponding to the user. The times of switching actions of each switching point of each video all will be added up. The switching action information which is recorded into the subsection statistic information of the currently playing video is used as a data basis for the subsection module 303 obtaining a subsection analysis of the video.

Classifying the user into groups to selectively record the switching action information can reduce pressure on the server to a certain extent, meanwhile acquiring more veracious and efficient statistic samples when the subsection module 303 calculates the subsection statistic information of each video, which removes sample information with little reference value to make the prediction results more accurate. In other embodiments, the recording module 302 may directly record the switching action information of all users, that is the recording module 302 regards all users as a statistic sample, and does not classify the users into groups. In this embodiment, the classifying module 301 can be left out.

The subsection module 303 calculates the subsection statistic information of each video to obtain a gathering degree and sets a piecewise spot of each video. The subsection module 303 calculates a weighted sum of times of all switching points of the video with a predetermined video length the as a gathering degree of each switching gathering area after receiving a request of a specified user to play a selected video. For example, the user named C requests to play the video named D, the subsection module 303 calculates a weighted sum of times of all switching points of the D video according to the subsection statistic information of D video, wherein the calculated weight of the C user is larger than the calculated weight of other users, and the value is set by the user or video service providers. The subsection module 303 calculates the gathering degree of each switching gathering area based on the calculated weighted sum of times of all switching points of the D video, wherein the switching gathering area represent a time point of D video where or around where the times of the switching point is greater, which means the users switch to the switching point or the area around the switching point many times.

In at least one embodiment, the step of acquiring a switching gathering area of A video comprises: traversing all times of A video; calculating a sum amount of the switching points of an area with the first predetermined time length (for example, 2 minutes) setting a time as a benchmark; for each time, while the sum amount of the switching points of the area with the first predetermined time length (for example, 2 minutes) setting the time as the benchmark is larger than a predetermined threshold value, the area with the first predetermined time length setting the time as a benchmark is marked as the switching gathering area of A video, furthermore, the way of setting the time as the benchmark can be to regard the time as a beginning or a center point, which is not limited in the embodiment. For example, while the time is regarded as the center point, the sum amount of the switching points of the area between the time N seconds before and the time N seconds behind is calculated in the process of traversing all times of A video. While the sum amount is larger than the predetermined threshold value, the area between the time N seconds before and the time N seconds behind is one of the switching areas.

For example, time B is at 50 minutes of A video, the sum amount of the switching points of the area between the time B 2 minutes before and the time B 2 minutes behind is 4 which is larger than the predetermined threshold value 3, so time between 48 minutes and 52 minutes is one of the switching gathering areas. In other embodiments, the switching gathering area can be set by video service providers according to the length of the videos or click heat of the videos and so on. A gathering degree of each switching gathering area can be obtained by calculating a weighted sum of times of all switching points of the video with a predetermined video length (such as 10 seconds). Usually, a time length (such as 5 seconds) before the center point of the switching gathering area and the other time length (such as 5 seconds) behind the center point of the switching gathering area are selected as the predetermined video length to calculate the gathering degree of the switching gathering area. The center point of the switching gathering area is the switching point with maximum weighted sum of times of the switching gathering area. Certainly, the time length before the center point of the switching gathering area and the other time length behind the center point of the switching gathering area can be different. For example, the time length before the center point of the switching gathering area can be 7 seconds, the other time length behind the center point of the switching gathering area can be 3 seconds. Finally, a piecewise spot is set on the basis of the gathering degree. The piecewise spot can be set on the center point of the switching gathering area or around the center point of the switching gathering area while the gathering degree of the switching gathering area is larger than a predetermined value, which is determined by the video service providers. In at least one embodiment, the piecewise spot can be set on the time point a second predetermined time length (such as 10 seconds) before the center point of the switching gathering area while the gathering degree of the switching gathering area is larger than a predetermined value.

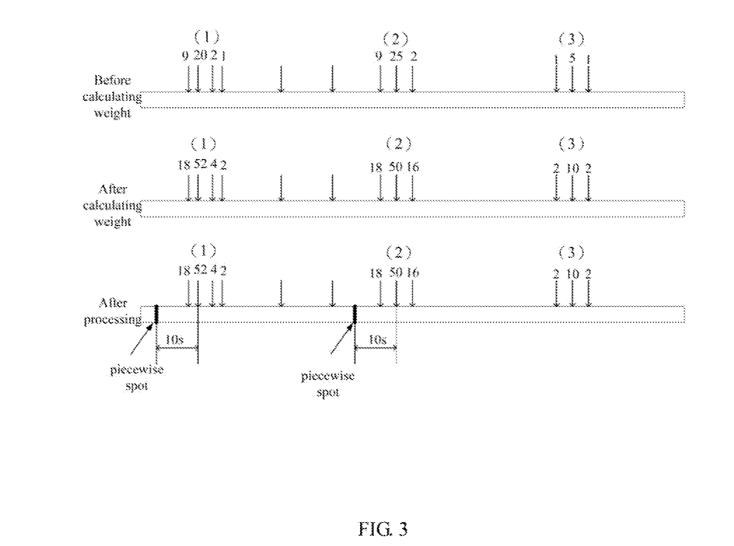

FIG. 3 illustrates an embodiment of a process of calculating a piecewise spot of the selected video according to the subsection statistics information of a selected video. The subsection statistics information only records the switching times of each switching point and the user corresponding to the switching point. Area (1) illustrates 4 switching points, respectively recording the switching times 9, 20, 2, 1, wherein 9 represents the switching action of 9 users (a same user doing the switching action 2 times represents 2 users) happens in the switching point corresponding to 9, which is same as the other recorded switching times. In at least one embodiment, the calculated weight of the specified user is larger than the calculated weight of other users while the weighted sum of times of the switching point of the selected video corresponding to all users of the subsection statistics information is calculated. For example, the current user C is the specified user who is sending the request for playing video D, supposing that the calculated weight of the current user C is set to be 8, and the calculated weight of the other users is set to be 2. That is the calculated weight of the switching action is 8 while the switching record corresponding to the switching action is a history record generated by the current user C and the calculated weight of the switching action is 2 while the switching record corresponding to the switching action is the history record generated by the other users, in condition that the current user C is sending the request for playing video D. In other words, the calculated weight of the switching action is 2 while the switching record corresponding to the switching action is the history record generated by the current user C in condition that the current user M is sending the request to play video D. As mentioned above, distinguishing one user from the other users while the weight of users is calculated pays more attention to the behavior of the user and makes the prediction results more accurate. As set above, the weighted sum of the switching times of each switching point within area (1) can be calculated below: 9*2=18, 2*8+18*2=52, 2*2=4, 1*2=2. The formula 2*8+18*2=52 represents that 2 times of 20 times of switching action records is the history record generated by the current user C, 2 times of 20 times of switching action records is the history record generated by the other users in condition that the current user C is sending the request to play video D. The weighted sum of the switching times of each switching point within area (2), area (3) can be calculated in the same way, and the calculated results of are displayed on FIG. 3. The switching gathering degree is calculated on the basis of the calculated weighted sum of the switching times of each switching point. First, the switching point with maximal weighted sum of times of each switching gathering area is selected as a center point of each switching gathering area, for example, the weighted sum of times of the switching point of the switching times 20 is 52 which is maximal weighted sum of times of the switching gathering area (1), comparing with the weighted sum of times of the other 3 switching points within the switching gathering area (1); second, a time length (for example, 5 seconds which is not marked on FIG. 3) before the center point and the same time length (5 seconds) behind the center point are selected to make the total time length reach a first predetermined time length, supposing that, the 4 switching points are within the first predetermined time length; third, the weighted sum of times of all switching points of the video with the predetermined video length is calculated as the gathering degree of each switching gathering area, the gathering degree of area (1), area (2), area (3) are respectively calculated below: area (1) 18+52+4+2=76, area (2) 18+50+16=84, area (3) 2+10+2=14; Forth, the time point of a second predetermined time length before the center point of the switching gathering area is set as the piecewise spot while the gathering degree of some switching gathering area is larger than a predetermined value. In at least one embodiment, the predetermined value is 50, obviously the gathering degree of area (1) and area (2) are larger than the predetermined value 50, so the piecewise spot will be set in area (1) and area (2). However, the gathering degree of (3) is smaller than the predetermined value 50, so the piecewise spot will not be set in area (3). For example, the second predetermined time length can be 10 seconds, so the piecewise spot can be set in 10 seconds before the center of each area, which makes sure that the video content around the center of each area must be downloaded in the process of beforehand downloading video.

The transmitting module 304 controls the video server 1 to supply a multi-threading transmission of video content to multiple client devices 2. The multi-threading transmission means that the video server 1 transmits the video streaming behind the beginning of the video to multiple client devices 2; meanwhile, the video server 1 also allocates system resources to transmit the video streaming behind each piecewise spot of the video to multiple client devices 2. In the view of the multiple client devices 2, the video streaming behind the beginning of the video and the video streaming behind each piecewise spot of the video are all being downloaded beforehand while a user is viewing a video from the beginning. The user has no need to wait, and can directly glide the video because the video streaming behind each piecewise spot of the video has been beforehand downloaded, therefore, the user can drag progress bar to any piecewise spot without delay in viewing. In at least one embodiment, the video streaming behind the current viewing piecewise spot will be stopped downloading to allocate system resources to quicken the downloading speed of the video streaming behind another piecewise spot while the user is detected to switch a current viewing piecewise spot to another piecewise spot, furthermore, the switching action does not effect the beforehand downloading of the video streaming behind the other piecewise spot.

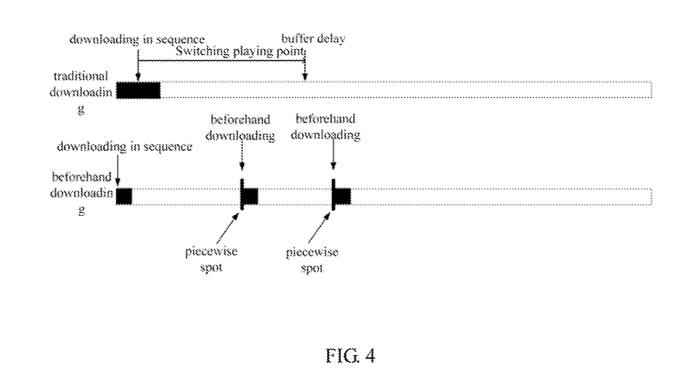

FIG. 4 illustrates an effect contrast between the method for beforehand downloading video in at least one embodiment of the present disclosure and the traditional method for downloading video. As mentioned above, during the controlling of the transmitting module 304, the video server 1 downloads video streaming in sequence to multiple client devices 2, meanwhile allocates system resources to download the video streaming behind each subsection statistic of the video to multiple client devices 2. Traditionally, a video buffer waits while a switching action appears during the process of downloading video streaming in sequence, which leads to a buffering of the video. The beforehand downloading video system in at least one embodiment supplies a method for downloading the video streaming behind each subsection statistic of the video beforehand, so the buffer delay can be avoided while the switching action appears in the process of downloading video streaming in sequence.

Referring to FIG. 5, a flowchart is presented in accordance with an embodiment of a method 500 for classifying the user into an appropriate user group, and the function modules 301-304 as FIG. 2 illustrates are executed by the processor 10. The method 500 is provided by way of example, as there are a variety of ways to carry out the method. The method 500 described below can be carried out using the configurations illustrated in FIG. 2, for example, and various elements of these figures are referenced in explaining the method 500. Each block shown in FIG. 2 represents one or more processes, methods, or subroutines, carried out in the exemplary method 500. Additionally, the illustrated order of blocks is by example only and the order of the blocks can change. The method 500 can begin at block 502.

At block 502, the classifying module 301 receives a request by a user from the client device 2 to play a video.

At block 504, the classifying module 301 records the type of the video and counts the times of the user viewing videos of the same type with the video.

At block 506, the classifying module 301 determines the times of the user viewing videos and regards the user as a high frequency user for viewing videos while the times of a user viewing videos exceeds a predetermined time.

At block 508, the classifying module 301 classifies the user into the user group corresponding to the type of video viewed. For example, the times of the user viewing movies exceeds the predetermined times (such as 15 times), the user will be classified into a movie group.

At block 510, the classifying module 301 updates the user classifying information stored in database in real-time.

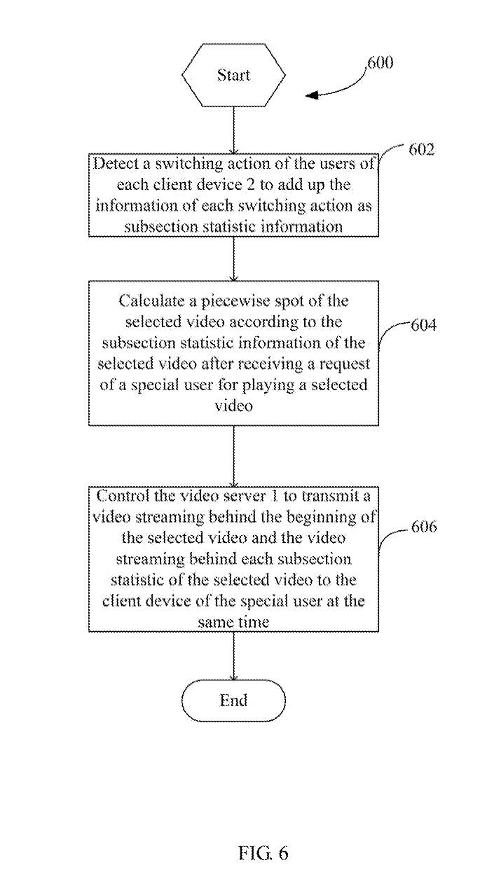

Referring to FIG. 6, a flowchart is presented in accordance with an embodiment of a method 600 for beforehand downloading video, and the function modules 301-304 as FIG. 2 illustrates are executed by the processor 10. Each block shown in FIG. 6 represents one or more processes, methods, or subroutines, carried out in the exemplary method 600. Additionally, the illustrated order of blocks is by example only and the order of the blocks can be changed. The method 600 can begin at block 602.

At block 602, the recording module 302 continuously detects a switching action of the users of each client device 2 to add up the information of each switching action as subsection statistic information; wherein the information of the switching action includes a switching point and the user corresponding to the switching action.

At block 604, the subsection module 303 calculates a piecewise spot of the selected video according to the subsection statistic information of the selected video after receiving a request of a specified user for playing a selected video.

At block 606, the transmitting module 304 controls the video server 1 to transmit a video streaming behind the beginning of the selected video and the video streaming behind each subsection statistic of the selected video to the client device of the specified user at the same time.

The embodiments shown and described above are only examples. Many details are often found in the art such as the other features of a device and method for beforehand downloading video. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A system for beforehand downloading video, executed in a video server coupled to multiple client devices and accessed though the multiple client devices by different users, the system comprising:
at least one processor;
a database coupled to the at least one processor; and
a storage unit coupled to the at least one processor, the storage unit configured to store one or more programs that are executed by the at least one processor, the one or more programs comprising instructions for:
detecting a switching action of the users of each client device to add up information of each switching action as subsection statistic information;
calculating a piecewise spot of the selected video according to the subsection statistic information of the selected video after receiving a request of a specified user for playing a selected video; and
controlling the video server to transmit a video streaming behind the beginning of the selected video and the video streaming behind each piecewise spot of the selected video to the client device of the specified user at the same time.

2. The system as claimed in claim 1, wherein the information of the switching action includes a switching point and the user corresponding to the switching action.

3. The system as claimed in claim 2, wherein the one or more programs further comprises instructions for:
classifying the user into a group corresponding to a predetermined video type while the times of the user viewing the video belonging to the predetermined video type exceeds a predetermined times.

4. The system as claimed in claim 2, wherein the step of detecting the switching action of the users of each client device to add up the information of each switching action as the subsection statistic information comprises:
adding up the information of the switching action of the user as the subsection statistic information while the user belongs to the group corresponding to the predetermined video type; and
not adding up the information of the switching action of the user as the subsection statistic information while the user does not belong to the group corresponding to the predetermined video type.

5. The system as claimed in claim 2, wherein the step of calculating the piecewise spot of the selected video according to the subsection statistics information of the selected video after receiving the request of the specified user for playing the selected video comprises:
calculating weighted sum of times of each switching point of the selected video corresponding to all users of the subsection statistics information;
acquiring a switching gathering area of the selected video; and
selecting the switching point with maximal weighted sum of times of each switching gathering area as a center point of each switching gathering area.

6. The system as claimed in claim 5, wherein the step of calculating the piecewise spot of the selected video according to the subsection statistics information of the selected video after receiving the request of the specified user for playing the selected video further comprises:
selecting a time length before the center point and the other time length behind the center point to make the total time length reach a first predetermined time length;
calculating weighted sum of times of all switching points of the video with a predetermined video length the as a gathering degree of each switching gathering area; and
setting the time point in a second predetermined time length before the center point of the switching gathering area as the piecewise spot while the gathering degree of the switching gathering area is larger than a predetermined value.

7. The system as claimed in claim 6, wherein the calculated weight of the specified user is larger than the calculated weight of other users while the weighted sum of times of each switching point of the selected video corresponding to all users of the subsection statistics information is calculated.

8. The system as claimed in claim 5, wherein the step of acquiring the switching gathering area of the selected video comprises:
traversing all times of the selected video;
calculating a sum amount of the switching points of an area with the first predetermined time length setting a time as a benchmark; and
making the area with the first predetermined time length setting the time as the benchmark as the switching gathering area while the sum amount is larger than a predetermined threshold value.

9. A method for beforehand downloading video, executed in a video server connected to multiple client devices and accessed though the multiple client devices by different users, the method comprising:
detecting a switching action of the users of each client device to add up information of each switching action as subsection statistic information;
calculating a piecewise spot of the selected video according to the subsection statistics information of the selected video after receiving a request of a specified user for playing a selected video; and
controlling the video database to transmit a video streaming behind the beginning of the selected video and the video streaming behind each piecewise spot of the selected video to the client device of the specified user at the same time.

10. The method as claimed in claim 9, wherein the information of the switching action includes a switching point and the user corresponding to the switching action.

11. The method as claimed in claim 10, further comprising:
classifying the user into a group corresponding to the video type while the times of some user viewing the video belonging to some video type exceeds a predetermined times;
adding up the information of the switching action of the user as the subsection statistic information while the user belongs to the group corresponding to the predetermined video type; and
not adding up the information of the switching action of the user as the subsection statistic information while the user does not belong to the group corresponding to the predetermined video type.

12. The method as claimed in claim 10, wherein the step of calculating the piecewise spot of the selected video according to the subsection statistics information of the selected video after receiving the request of the specified user for playing the selected video comprises:
calculating weighted sum of times of each switching point of the selected video corresponding to all users of the subsection statistics information;
acquiring a switching gathering area of the selected video; and
selecting the switching point with maximal weighted sum of times of each switching gathering area as a center point of each switching gathering area.

13. The method as claimed in claim 12, wherein the step of calculating the piecewise spot of the selected video according to the subsection statistics information of the selected video after receiving the request of the specified user for playing the selected video further comprises:
selecting a time length before the center point and the other time length behind the center point to make the total time length reach a first predetermined time length;
calculating weighted sum of times of all switching points of the video with a predetermined video length the as a gathering degree of each switching gathering area; and
setting the time point in a second predetermined time length before the center point of the switching gathering area as the piecewise spot while the gathering degree of the switching gathering area is larger than a predetermined value.

14. The method as claimed in claim 13, wherein the calculated weight of the specified user is larger than the calculated weight of other users while the weighted sum of times of each switching point of the selected video corresponding to all users of the subsection statistics information is calculated.

15. The method as claimed in claim 12, wherein the step of acquiring the switching gathering area of the selected video comprises:
traversing all times of the selected video;
calculating a sum amount of the switching points of an area with the first predetermined time length setting a time as a benchmark; and
making the area with the first predetermined time length setting the time as the benchmark as the switching gathering area while the sum amount is larger than a predetermined threshold value.
